(19) United States
(12) Patent Application Publication
(10) Pub. No.: US 2016/0116409 A1
(43) Pub. Date: Apr. 28, 2016

(54) Color-Sensitive Image Sensor With Embedded Microfluidics And Associated Methods

(71) Applicant: OmniVision Technologies, Inc., Santa Clara, CA (US)

(72) Inventors: Dominic Massetti, San Jose, CA (US); Bowei Zhang, Fremont, CA (US)

(73) Assignee: OmniVision Technologies, Inc.

(21) Appl. No.: 14/526,161

(22) Filed: Oct. 28, 2014

(51) Int. Cl. G01N 21/64; G01N 21/05

(52) U.S. Cl. CPC G01N 21/6428; G01N 21/6486; G01N 21/05

(57) ABSTRACT

A color-sensitive image sensor with embedded microfluidics includes a silicon substrate having (a) at least one recess partly defining at least one embedded microfluidic channel and (b) a plurality of photosensitive regions for generating position-sensitive electrical signals in response to light from the at least one recess, wherein at least two of the photosensitive regions are respectively located at at least two mutually different depth ranges, relative to the at least one recess, to provide color information. A wafer-level manufacturing method produces a plurality of such color-sensitive image sensors. A method for generating a color image of a fluidic sample includes performing imaging, onto a plurality of photosensitive regions of a silicon substrate, of a fluidic sample deposited in a microfluidic channel embedded in the silicon substrate, and generating color information based upon penetration depth of light into the silicon substrate.

### BACKGROUND

The results of biological or chemical assays are frequently determined through use of optical imaging methods. Assay readout based upon fluorescence or chemiluminescence imaging are replacing more traditional methods such as gel electrophoresis methods, non-imaging based flow cytometry, and mass spectrometry. Fluorescence and chemiluminescence imaging are particularly well suited for multiplexed assay readout since both color and spatial location information are available to distinguish between different types of sample components or processes.

Modern optical imaging based diagnostics instruments utilize a digital image sensor such as a charge-coupled device (CCD) sensor or a complementary-metal-oxide semiconductor (CMOS) image sensor. While CCD sensors, even less than a decade ago, used to be the preferred image sensor type due to superior sensitivity, CMOS image sensors are gradually taking over the market. CMOS image sensors are associated with significantly lower manufacturing cost than CCD sensors and are steadily improving in performance. Many applications requiring particularly high sensitivity may now use so-called backside illuminated CMOS image sensors, wherein light collection efficiency is improved over conventional frontside illuminated CMOS image sensors by placing electrical connections to the photodiodes away from the optical paths. These developments have led to a general reduction in the cost of optical imaging based diagnostics instruments attributable to the image sensor. In many cases, the instrument cost is dominated by other components such as optics (e.g., lenses, filters, and mirrors) and fluidics components.

Currently, effort is being put into developing compact and low cost optical imaging systems, especially for use at the point of care and/or in low-resource settings. However, such imaging systems typically still cost a few thousand dollars, which slows market adoption. Additionally, systems intended for point of care and/or low resource settings must be sturdy, maintenance free, and operable by minimally trained staff, which makes it especially challenging to meet cost requirements. For these reasons, many point of care and/or low-resource settings rely on visual readout of lateral flow strips, resulting in poor (if any) quantitation, limited (if any) multiplexing capability, and subjective readout. Consequently, patients in such settings do not receive optimal care.

### SUMMARY

In an embodiment, a color-sensitive image sensor with embedded microfluidics includes a silicon substrate having (a) at least one recess partly defining at least one embedded microfluidic channel and (b) a plurality of photosensitive regions for generating position-sensitive electrical signals in response to light from the at least one recess, wherein at least two of the photosensitive regions are respectively located at at least two mutually different depth ranges, relative to the at least one recess, to provide color information.

In an embodiment, a method for generating a color image of a fluidic sample includes performing imaging, onto a plurality of photosensitive regions of a silicon substrate, of a fluidic sample deposited in a microfluidic channel embedded in the silicon substrate, and generating color information based upon penetration depth of light into the silicon substrate.

In an embodiment, a wafer-level method for manufacturing a plurality of color-sensitive image sensors with embedded microfluidics includes (a) processing the frontside of a silicon wafer to produce a plurality of doped regions, wherein the doped regions are located at a plurality of mutually different depth ranges relative to the plane of the backside of the silicon wafer, (b) processing the backside to partly define a plurality of embedded microfluidic channels by producing, in the plane of the backside, recesses having depth relative to the plane of the backside such that the mutually different depth ranges respectively correspond to penetration depth of light of mutually different wavelength ranges into the silicon wafer from the recesses, and (c) dicing the silicon substrate to singulate therefrom the color-sensitive image sensors, wherein each of the color-sensitive image sensors includes at least one of the embedded microfluidic channels.

### BRIEF DESCRIPTION OF THE DRAWINGS

FIG. 1 illustrates a color-sensitive image sensor with embedded microfluidics, according to an embodiment.

FIG. 2 shows plots of the wavelength-dependent penetration depth of light into silicon.

FIG. 3 illustrates a color-sensitive image sensor with embedded microfluidics, which includes photosensitive regions for detection of light of non-overlapping wavelength ranges, according to an embodiment.

FIG. 4 illustrates one color-sensitive image sensor with embedded microfluidics, which includes photosensitive regions for detection of light of overlapping wavelength ranges, according to an embodiment.

FIG. 5 illustrates another color-sensitive image sensor with embedded microfluidics, which includes photosensitive regions for detection of light of overlapping wavelength ranges, according to an embodiment.

FIG. 6 illustrates one layout of color pixel groups of the color-sensitive image sensor of FIG. 1, according to an embodiment.

FIG. 7 illustrates another layout of color pixel groups of the color-sensitive image sensor of FIG. 1, according to an embodiment.

FIG. 8 illustrates yet another layout of color pixel groups of the color-sensitive image sensor of FIG. 1, according to an embodiment.

FIGS. 9A and 9B illustrate lens-free imaging of sample components, using the color-sensitive image sensor of FIG. 1, according to an embodiment.

FIG. 10 illustrates a color-sensitive image sensor with multilevel microfluidics, according to an embodiment.

FIG. 11 illustrates a color-sensitive image sensor configured to reduce spectral blur, according to an embodiment.

FIG. 12 illustrates a sample imaging system that utilizes the color-sensitive image sensor of FIG. 1 to generate a color image of a fluidic sample, according to an embodiment.

FIG. 13 illustrates a method for generating a color image of a fluidic sample, utilizing a color-sensitive image sensor with embedded microfluidics, according to an embodiment.

FIG. 14 illustrates a method for color fluorescence imaging of a fluidic sample, utilizing a color-sensitive image sensor with embedded microfluidics, according to an embodiment.

FIG. 15 is a flowchart illustrating a wafer-level method for manufacturing a plurality of color-sensitive image sensors with embedded microfluidics, according to an embodiment.

FIG. 16 illustrates steps of the method of FIG. 15, according to an embodiment.

### DETAILED DESCRIPTION OF THE EMBODIMENTS

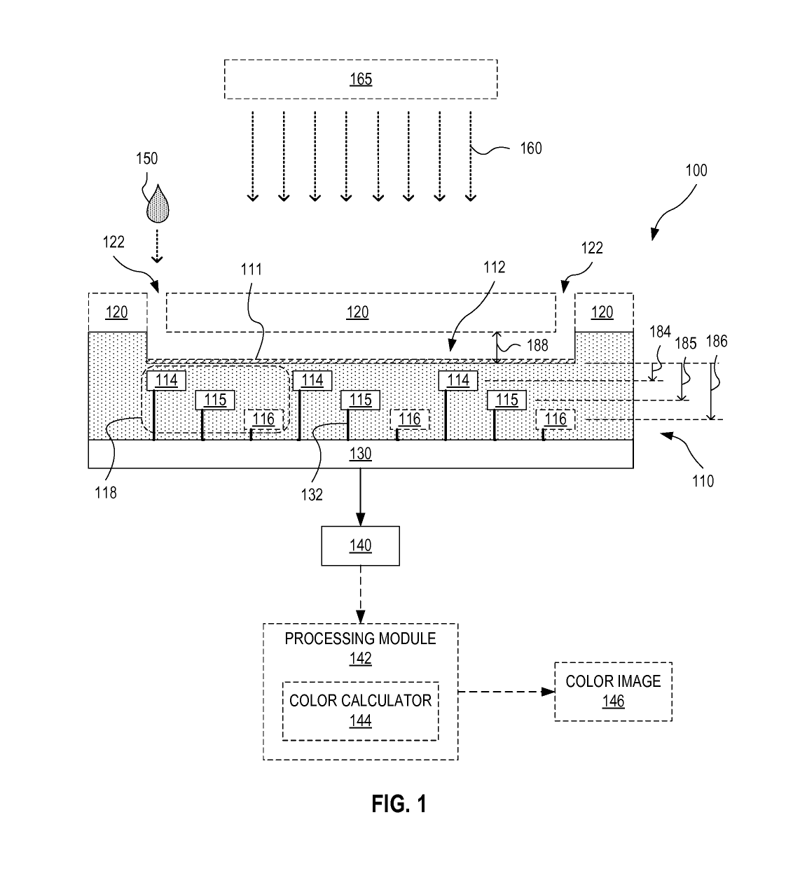

FIG. 1 illustrates, in cross-sectional side view, a color-sensitive image sensor 100 with embedded microfluidics, for lens-free color imaging of a fluidic sample 150. Color-sensitive image sensor 100 provides a compact, inexpensive, and easily operated solution to fluidic sample imaging, and is applicable, for example, as a diagnostics device in point of care and/or low-resource settings. Color-sensitive image sensor 100 may be manufactured at low cost using wafer-level CMOS technology. Certain embodiments of color-sensitive image sensor 100 may be produced at cost compatible with single-use scenarios, wherein color-sensitive image sensor 100 is discarded after a being used only one time. In addition, color-sensitive image sensor 100 may image fluidic sample 150 with high resolution and sensitivity. Color-sensitive image sensor 100 generates both spatial and color information about fluidic sample 150 and is therefore well suited for multiplexed readout of fluidic sample 150 and/or processes associated with fluidic sample 150.

Color-sensitive image sensor 100 includes a silicon substrate 110 having a plurality of photosensitive regions 114, a plurality of photosensitive regions 115, a recess 112, and electronic circuitry 130. Herein, “silicon substrate” refers to a substrate based upon silicon and/or derivative(s) of silicon such as Silicon Germanium and Silicon Carbide. A “silicon substrate”, as referred to herein, may include (a) dopants that locally alter properties of the silicon or silicon-derived material and (b) conductive material, such as metal, forming electronic circuitry.

Color-sensitive image sensor 100 may further include a cover 120. Recess 112 and cover 120 cooperate to define an embedded microfluidic channel in color-sensitive image sensor 100. Cover 120 includes through-holes 122 that form inlet and outlet ports for the microfluidic channel associated with recess 112. It is understood that cover 120 may be provided separate from silicon substrate 110, such that color-sensitive image sensor 100 may exist, be manufactured, and/or be sold without cover 120. In certain embodiments, recess 112 is substantially planar. Recess 112 has depth 188 relative to the surface of silicon substrate 110 that contacts cover 120, such that recess 112 and cover 120 cooperate to define a microfluidic channel having a height that equals depth 188. Depth 188 is, for example, in the range between a fraction of a micron and a few millimeters.

Color-sensitive image sensor 100 determines color-information based upon wavelength-dependent penetration depth of light from recess 112 into silicon substrate 110. Photosensitive regions 114 and 115 generate electrical signals in response to light incident thereupon. Photosensitive regions 114 and 115 are located at mutually different depths 184 and 185, respectively, relative to recess 112. Each of depth 184 and 185 refers to a depth range respectively occupied by photosensitive regions 114 and 115. Photosensitive regions 114 and 115 are responsive to light having penetration depth, into silicon substrate 110 from recess 112, coinciding with depths 184 and 185, respectively.

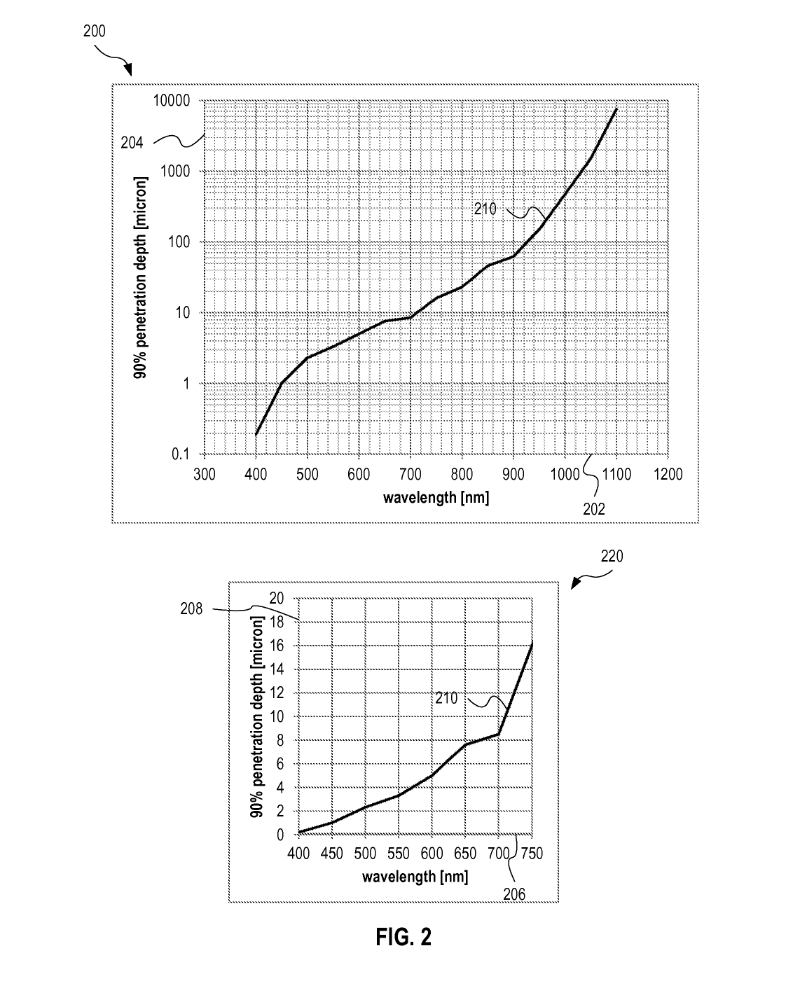

FIG. 2 shows two plots 200 and 220 illustrating the wavelength-dependent penetration depth 210 of light into silicon. Plot 200 shows the penetration depth 210 of light into silicon for wavelengths in the range from 400 nanometers (nm) to 1100 nm. Plot 200 plots the penetration depth as 90% penetration depth in micron on a logarithmic scale (axis 204) versus wavelength in nm (axis 202). Plot 220 shows the penetration depth 210 of light into silicon for visible light. Plot 220 plots the penetration depth as 90% penetration depth in micron on a linear scale (axis 208) versus wavelength in nm (axis 206). As shown in plots 200 and 220, the penetration depth of light into silicon is highly wavelength dependent. Furthermore, the penetration depth of light into silicon depends monotonically on the wavelength. Hence, there is a one-to-one (injective) correspondence between penetration depth and wavelength. The visible spectrum spans a penetration depth range from 0.19 micron (for wavelength of 400 nm) to 16 micron (for wavelength of 750 nm). This penetration depth range is greater than silicon manufacturing resolution and yet is sufficiently small to be compatible with desirable thickness of silicon substrate 110 (FIG. 1).

Referring again to FIG. 1, since the penetration depth of light into silicon substrate 110 is wavelength dependent (as shown in FIG. 2), photosensitive regions 114 and 115 are sensitive to light of mutually different wavelength ranges. Accordingly, photosensitive regions 114 and 115 provide color resolution. Color-sensitive image sensor 100 is configured with color pixel groups 118. Each color pixel group 118 includes at least one photosensitive region 114 and at least one photosensitive region 115. For clarity of illustration, only one color pixel group 118 is indicated in FIG. 1. Color-sensitive image sensor 100 may include any number of color pixel groups 118 to achieve a desired resolution. For example, color-sensitive image sensor may include an array of one thousand to millions of color pixel groups 118, wherein each color pixel group 118 has cross-sectional area in the range from about one square micron to 100 square micron.

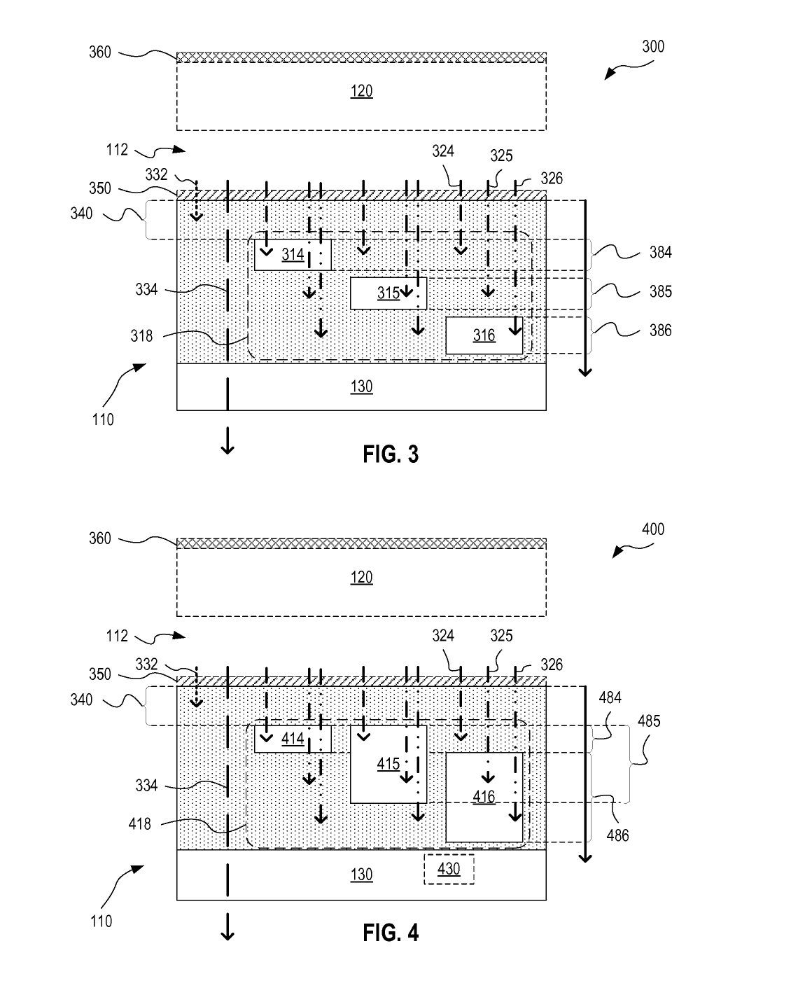

Without departing from the scope hereof, color pixel group 118 may include one or more additional photosensitive regions, located at depth(s) different from depths 184 and 185, which are sensitive to light of wavelength range(s) different from the wavelength ranges associated with photosensitive regions 114 and 115. In one example, color pixel group 118 further includes a photosensitive regions 116 located at depth 186 which is different from depths 184 and 185, such that color-sensitive image sensor 100 distinguishes between light of three different wavelength ranges. It follows from FIG. 2 that color-sensitive image sensor 100 may be configured with photosensitive regions 114 and 115, and optionally photosensitive region 116 at respective depths 184, 185, and 186 associated with different portions of the visible spectrum. In certain embodiments, color-sensitive image sensor 100 is configured with photosensitive regions 114, 115, and 116 that enable distinction between light belonging to red, green, and blue portions of the visible spectrum. However, photosensitive regions 114, 115, and 116 may have depth different from those illustrated in FIG. 1, without departing from the scope hereof. For example, the depth ranges of two or more of photosensitive regions 114, 115, and 116 may overlap. Certain exemplary configurations are discussed below in reference to FIGS. 3-5.

In one embodiment, photosensitive regions 114, 115, and 116 are negatively doped (n-type doped) regions of silicon substrate 110. In another embodiment, photosensitive regions 114, 115, and 116 are positively doped (p-type doped) regions of silicon substrate 110. Photosensitive regions 114, 115, and optionally 116 are communicatively coupled with electronic circuitry 130 via electrical connections 132. For clarity of illustration, only one electrical connection 132 is labeled in FIG. 1. Electronic circuitry 130 processes electrical signals generated by photosensitive regions 114, 115, and optionally 116 in response to light and outputs an electrical signal 140. Electrical signal 140 includes position-sensitive color information and is thus representative of a color image of fluidic sample 150 deposited in the microfluidic channel defined by recess 112 and cover 120.

Since electrical connections 132 are located away from the optical paths from recess 112 to photosensitive regions 114, 115, and 116, color-sensitive image sensor 100 may be implemented as a backside illuminated CMOS image sensor. Thus, color-sensitive image sensor 100 may benefit from higher light collection efficiency than a frontside illuminated CMOS image sensor.

In one embodiment, electronic circuitry 130 is communicatively coupled with a processing module 142. Processing module 142 includes a color calculator 144 that processes electrical signal 140 to assign a color or a plurality of color values, such as red, green, and blue intensities, to color pixel group 118. Processing module 142 may thus output a color image 146 of fluidic sample 150.

In another embodiment, processing module 142 is integrated into color-sensitive image sensor 100. In one example, processing module 142 is located on a electronic circuit board that also holds color-sensitive image sensor 100. In another example, processing module 142 is integrated in electronic circuitry 130. Processing module 142 may be implemented as logic gates to perform algebraic operations of electrical signals generated by photosensitive regions 114, 115, and optionally 116.

In one exemplary use scenario, a light source 165 illuminates fluidic sample 150, deposited in the microfluidic channel formed by recess 112 and cover 120, with illumination 160. Illumination 160 is, for example, fluorescence excitation illumination that excites fluorophores in fluidic sample 150. In one embodiment, color-sensitive image sensor 100 includes light source 165. In another embodiment, color-sensitive image sensor 100 is configured to be inserted into a separate instrument that includes light source 165. Light source 165 includes, for example, one or more light emitting diodes, one or more lasers, and/or a white light source. Illumination 160 may be a single wavelength range of light or sequentially applied light of different wavelengths/wavelength ranges. Cover 120 may be at least partially transmissive to illumination 160.

In one embodiment, color-sensitive image sensor is a disposable, i.e., single-use, device configured for readout by a separate, reusable instrument that may include light source 165, processing module 142, and/or circuitry for outputting color image 146.

Optionally, color-sensitive image sensor 100 may include a coating 111 on silicon substrate 110 at recess 112. Coating 111 is, for example, an antireflective coating that prevents image artifacts due to multiple reflections of light from the microfluidic channel associated with recess 112. In one example, coating 111 is an antireflective coating with thickness in the range between 10 and 200 nm.

Without departing from the scope hereof, color-sensitive image sensor 100 may include a plurality of recesses 112 partly defining a plurality of microfluidic channels. Cover 120 may include corresponding through-holes 122 to provide fluidic access to such a plurality of microfluidic channels. Furthermore, recess 112 may have shape different from the example illustrated in FIG. 1, without departing from the scope hereof. For example, recess 112 may extend out of the plane of the cross-section depicted in FIG. 1. Recess 112 may be non-linear, have corners, and/or be serpentine shaped. Such shapes may maximize the number of color pixel groups 118 in optical communication with fluidic sample 150.

FIG. 3 illustrates, in cross-sectional side view, one exemplary color-sensitive image sensor 300 with embedded microfluidics, which is an embodiment of color-sensitive image sensor 100 (FIG. 1). Color-sensitive image sensor 300 includes a plurality of color pixel groups 318, each including photosensitive regions 314, 315, and 316. For clarity of illustration, FIG. 3 shows only a portion of color-sensitive image sensor 300 associated with one color pixel group 318. Photosensitive regions 314, 315, and 316 are embodiments of photosensitive regions 114, 115, and 116, respectively, and color pixel group 318 is an embodiment of color pixel group 118.

Photosensitive regions 314, 315, and 316 respectively span depth ranges 384, 385, and 386, relative to the surface of silicon substrate 110 associated with recess 112. Depth ranges 384, 385, and 386 do not overlap. Depth ranges 384, 384, and 386 respectively coincide with penetration depth of light 324, 325, and 326 from the microfluidic channel defined by recess 112 and cover 120. Light 324, 325, and 326 have non-overlapping wavelength ranges. In one exemplary implementation, the wavelength ranges of light 324, 325, and 326 segregate the visible spectrum into red, green, and blue portions, such that color pixel group 318 generates three electrical signals directly corresponding to primary color information.

In an embodiment, color-sensitive image sensor 300 includes a coating 350 on silicon substrate 110 at recess 112. Coating 350 is, for example, an anti-reflective coating. In an embodiment, cover 120 includes a coating 360 which is, for example, a wavelength filter that filters fluorescence excitation illumination such as illumination 160.

In certain embodiments, silicon substrate 110 includes a layer 340 separating photosensitive regions 314, 315, and 316 from recess 112. Layer 340 absorbs light of wavelength shorter than the wavelength of light 324. However, layer 340 is not photosensitive. A surplus of p-type dopants in layer 340 may render layer 340 photo-insensitive. The p-type dopants are likely to annihilate any electrons generated therein in response to light incident thereupon before such electrons would be able to migrate to one of photosensitive regions 314 and 315 and 316.

In one exemplary use scenario, color-sensitive image sensor 300 is a fluorescence imaging device and light 324, 325, and 326 are fluorescence emission from fluidic sample 150. In this scenario, color-sensitive image sensor 300 may be operated with fluorescence excitation illumination 332 of wavelength shorter than the wavelength of light 324, 325, and 326, wherein layer 340 absorbs fluorescence excitation illumination 332 and thus serves as a fluorescence emission filter. Color-sensitive image sensor 300 may also be operated with fluorescence excitation illumination 334 of wavelength longer than the wavelength of light 324, 325, and 326, such that photosensitive regions 314, 315, and 316 substantially transmit fluorescence excitation illumination 334 to eliminate or reduce contribution of fluorescence excitation illumination 334 to electrical signals generated by color pixel group 318. In this use scenario, light 324, 325, and 326 may be associated with different types of fluorescence, such that distinction between light 324, 325, and 326 enables distinction between different types of sample components.

In another exemplary use scenario, color-sensitive image sensor 300 is a fluorescence imaging device, one of light 324, 325, and 326 is fluorescence excitation illumination, while the other two of light 324, 325, and 326 are fluorescence emission from fluidic sample 150. In this use scenario, light 325 and 326 may be associated with different types of fluorescence, such that distinction between light 324, 325, and 326 enables distinction between fluorescence excitation and fluorescence emission as well as distinction between different types of sample components. Without departing from the scope hereof, color-sensitive image sensor 300 may not include photosensitive regions 116, and distinguish between fluorescence excitation illumination and fluorescence emission by (a) detecting fluorescence excitation illumination using, e.g., photosensitive regions 114 and (b) detecting fluorescence emission using, e.g., photosensitive regions 115.

FIG. 4 illustrates, in cross-sectional side view, another exemplary color-sensitive image sensor 400 with embedded microfluidics, which is an embodiment of color-sensitive image sensor 100 (FIG. 1). Color-sensitive image sensor 400 is similar to color-sensitive image sensor 300 (FIG. 3) except that color pixel groups 318 are replaced by color pixel groups 418. Color pixel group 418 includes photosensitive regions 414, 415, and 416. Photosensitive regions 414, 415, and 416 are embodiments of photosensitive regions 114, 115, and 116, respectively, and color pixel group 418 is an embodiment of color pixel group 118.

Photosensitive regions 414, 415, and 416 respectively span depth ranges 484, 485, and 486, relative to the surface of silicon substrate 110 associated with recess 112. Depth range 484 overlaps with depth range 485. Depth range 484 overlaps with depth range 485. However, depth range 484 does not overlap with depth range 486. In one exemplary implementation, the wavelength ranges of light 324, 325, and 326 segregate the visible spectrum into red, green, and blue portions, and depth ranges 484, 485, and 486 are such that (a) blue intensity is the intensity measured by photosensitive region 414, (b) green intensity is the intensity measured by photosensitive region 415 minus the blue intensity, and (c) red intensity is the intensity measured by photosensitive region 416 minus the green intensity. In one embodiment, electronic circuitry 130 includes logic gates 430 that perform these algebraic operations to generate primary color information from electrical signals generated by photosensitive regions 414, 415, and 416.

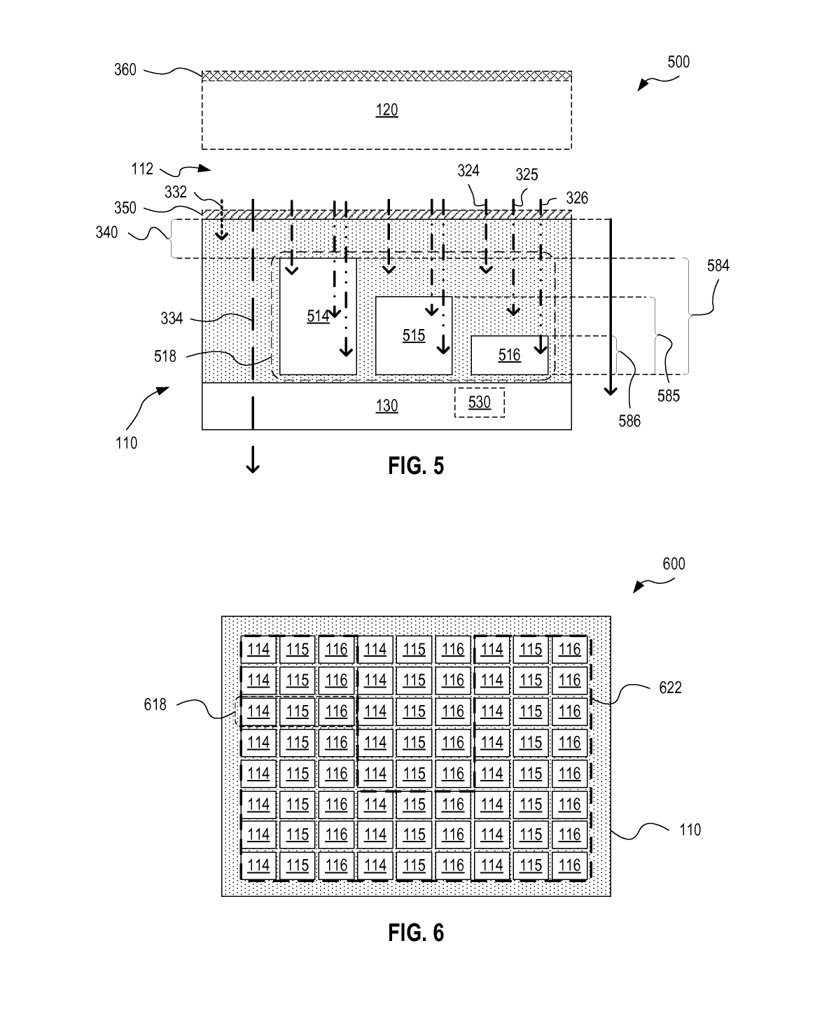

FIG. 5 illustrates, in cross-sectional side view, yet another exemplary color-sensitive image sensor 500 with embedded microfluidics, which is an embodiment of color-sensitive image sensor 100 (FIG. 1). Color-sensitive image sensor 500 is similar to color-sensitive image sensor 400 (FIG. 4) except that color pixel groups 418 are replaced by color pixel groups 518. Color pixel group 518 includes photosensitive regions 514, 515, and 516. Photosensitive regions 514, 515, and 516 are embodiments of photosensitive regions 114, 115, and 116, respectively, and color pixel group 518 is an embodiment of color pixel group 118.

Photosensitive regions 514, 515, and 516 respectively span depth ranges 584, 585, and 586, relative to the surface of silicon substrate 110 associated with recess 112. Depth ranges 584, 585, 586 extend to substantially identical maximum depth relative to recess 112. In an embodiment, all of photosensitive regions 514, 515, and 516 are optimally close to electronic circuitry 130 for easy transfer to electronic circuitry 130 of electrical signals, generated by photosensitive regions 514, 515, and 516. Depth range 584 is greater than depth range 585 and depth range 585 is greater than depth range 586. In one exemplary implementation, the wavelength ranges of light 324, 325, and 326 segregate the visible spectrum into red, green, and blue portions, and depth ranges 584, 585, and 586 are such that (a) red intensity is the intensity measured by photosensitive region 516, (b) green intensity is the intensity measured by photosensitive region 515 minus the intensity measured by photosensitive region 516, and (c) blue intensity is the intensity measured by photosensitive region 514 minus the intensity measured by photosensitive region 515. In one embodiment, electronic circuitry 130 includes logic gates 530 that perform these algebraic operations to generate primary color information from electrical signals generated by photosensitive regions 514, 515, and 516.

FIG. 6 is a diagram 600 illustrating one exemplary layout of color pixel groups of color-sensitive image sensor 100 (FIG. 1) implemented with a recess 622 and a plurality of color pixel groups 618. Color pixel group 618 is an embodiment of color pixel group 118. Color pixel group 618 includes photosensitive region 114, photosensitive region 115, and photosensitive region 116. Diagram 600 shows photosensitive regions 114, 115, and 116 and an outline of recess 622, projected onto a plane, of silicon substrate 110, which is orthogonal to the cross-section of FIG. 1. For clarity of illustration, only one color pixel group 618 is indicated in FIG. 6.

In this implementation of color-sensitive image sensor 100, photosensitive regions 114, 115, 116 are arranged in separate respective columns that repeat cyclically across color-sensitive image sensor 100. Photosensitive regions 114, 115, and 116 are, for example, (a) photosensitive regions 314, 315, and 315 of FIG. 3, (b) photosensitive regions 414, 415, and 415 of FIG. 4, or (c) photosensitive regions 514, 515, and 515 of FIG. 5.

Without departing from the scope hereof, this implementation of color-sensitive image sensor 100 may include fewer or more color pixel groups 618 than shown in diagram 600. Recess 622 may have shape different from that shown in diagram 600, and furthermore include two or more separate recesses that, together with cover 120, define two or more separate microfluidic channels.

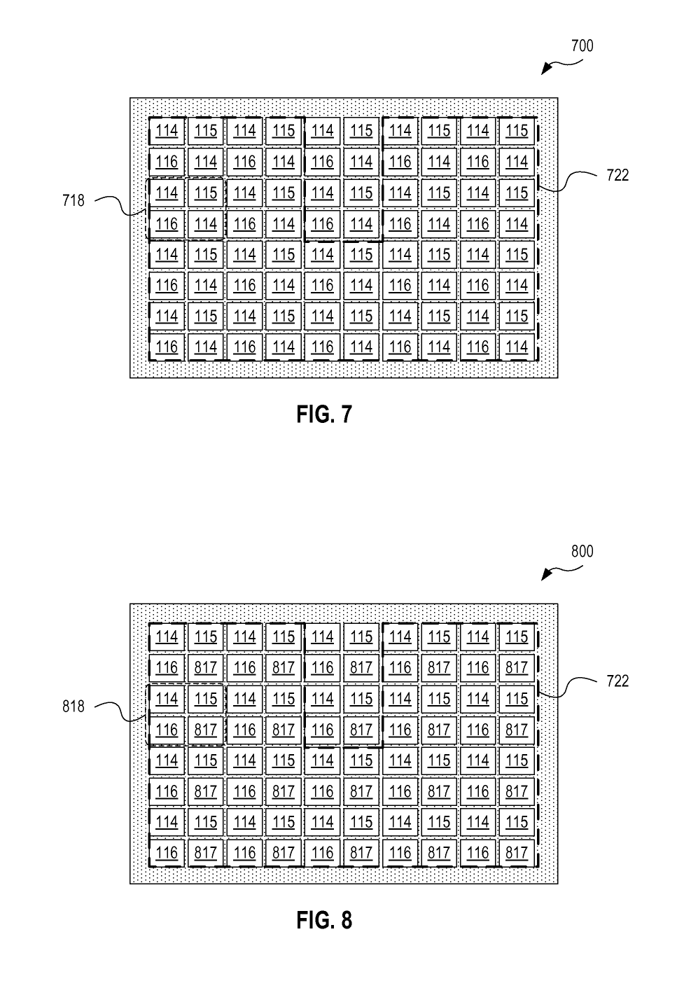

FIG. 7 is a diagram 700 illustrating another exemplary layout of color pixel groups of color-sensitive image sensor 100 (FIG. 1) implemented with a recess 722 and a plurality of color pixel groups 718. Color pixel group 718 is an embodiment of color pixel group 118. Color pixel group 718 includes two photosensitive regions 114, one photosensitive region 115, and one photosensitive region 116. Diagram 700 shows photosensitive regions 114, 115, and 116 and an outline of recess 722, projected onto a plane, of silicon substrate 110, which is orthogonal to the cross-section of FIG. 1. For clarity of illustration, only one color pixel group 718 is indicated in FIG. 7. Color pixel group 718 is configured with photosensitive regions 114, 115, and 116 in a two-by-two array.

FIG. 8 is a diagram 800 illustrating yet another exemplary layout of color pixel groups of color-sensitive image sensor 100 (FIG. 1) implemented with recess 722 (FIG. 7) and a plurality of color pixel groups 818. Color pixel group 818 is an embodiment of color pixel group 118. Color pixel group 818 includes one photosensitive region 114, one photosensitive region 115, one photosensitive region 116, and one photosensitive region 817. Photosensitive region 817 has a depth range, relative to recess 722, which is different from the depth ranges of photosensitive regions 114, 115, and 116. Diagram 800 shows photosensitive regions 114, 115, 116, and 817 and an outline of recess 722, projected onto a plane, of silicon substrate 110, which is orthogonal to the cross-section of FIG. 1. For clarity of illustration, only one color pixel group 818 is indicated in FIG. 8. Color pixel group 818 is configured with photosensitive regions 114, 115, 116, and 817 in a two-by-two array.

In an example A, photosensitive regions 114, 115, and 116 are photosensitive regions 314, 315, and 316, while photosensitive region 817 has a depth range that spans from the minimum to the maximum depth of photosensitive regions 314, 315, and 316. In an example B, photosensitive regions 114, 115, and 116 are photosensitive regions 414, 415, and 416, while photosensitive region 817 has a depth range that spans from the minimum to the maximum depth of photosensitive regions 414, 415, and 416. In examples A and B, photosensitive regions 114, 115, and 116 may provide color information, while photosensitive region 817 provides monochrome brightness information.

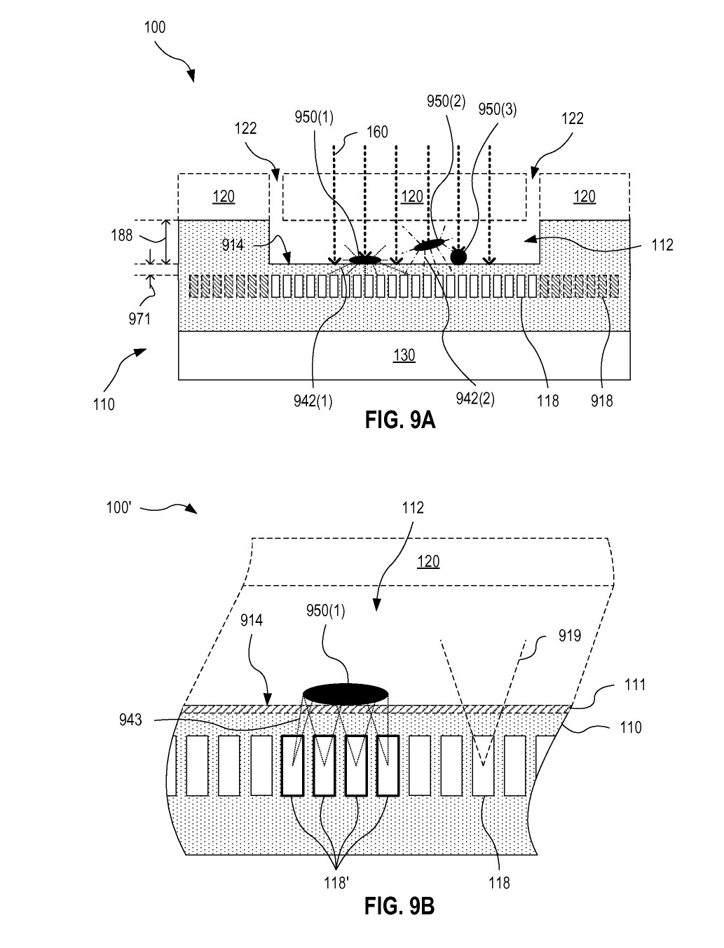

FIG. 9A illustrates, in cross-sectional sideview, color-sensitive image sensor 100 (FIG. 1), together with lens-free imaging of sample components 950(1) and 950(2) of fluidic sample 150. FIG. 9B shows a section 100′ of color-sensitive image sensor 100, which includes sample component 950(1). FIGS. 9A and 9B are best viewed together. For clarity of illustration, electrical connections 132 are not shown in FIGS. 9A and 9B, and optional coating 111 is not shown in FIG. 9A.

Silicon substrate 110 includes a light-receiving surface 914 that receives light propagating from recess 112 toward color pixel groups 118. In embodiments that include coating 111, light receiving surface 914 is the interface between coating 111 and the microfluidic channel defined by recess 112 and optional cover 120.

Optionally, silicon substrate 110 includes color pixel groups 918 (similar to color pixel groups 118) located in portions not in optical communication with recess 112. For clarity of illustration, not all color pixel groups 118 and 918 are labeled in FIG. 9A. In one example of use, color pixel groups 918 are dark pixels used to measure electronic noise associated with color pixel groups 118 and 918. Such electronic noise measured by color pixel groups 918 may be subtracted from electrical signals generated by color pixel groups 118 to produce a noise-subtracted color image 146.

Sample components 950(1) and 950(2) produce light emission 942(1) and 942(2), respectively. In one example, sample components 950(1) and 950(2) are fluorescently labeled and light emission 942(1) and 942(2) are fluorescence emission generated in response to fluorescence excitation illumination such as illumination 160. In another example, light emission 942(1) and 942(2) are chemiluminescence emission. In yet another example, light emission 942(1) and 942(2) are scattering of illumination 160 on sample components 950(1) and 950(2), respectively. Without departing from the scope hereof, one or both of sample components 950(1) and 950(2) may instead be a sample process such as a chemiluminescence reaction. A sample component 950(3), of fluidic sample 150, does not emit illumination. Hence, sample component 950(3) does not contribute to electrical signals generated by color pixel groups 118. In a fluorescence imaging scenario, sample component 950(3) is, for example, a sample component that is not fluorescently labeled.

Silicon substrate 110 transmits at least portions of emission 942(1) and 942(2) to color pixel groups 118. In a fluorescence imaging scenario, color pixel groups 118 thus detect at least portions of fluorescence emission 942(1) and 942(2), whereby color pixel groups 118 detect fluorescently labeled sample components 950(1) and 950(2). Accordingly, in the fluorescence imaging scenario, color pixel groups 118 generate at least a portion of a fluorescence color image 146 indicating fluorescently labeled sample components 950(1) and 950(2). In a chemiluminescence imaging scenario, color pixel groups 118 detect at least portions of chemiluminescence emission 942(1) and 942(2), whereby color pixel groups 118 detect sample components (or processes) 950(1) and 950(2).

Section 100′ includes sample component 950(1). Each color pixel group 118 has an acceptance angle 919. For clarity of illustration, acceptance angle 919 is indicated only for one color pixel group 118. Acceptance angle 919 represents a composite acceptance angle for individual photosensitive regions within color pixel group 918. Therefore, acceptance angle 919 may be wavelength dependent. In an embodiment, acceptance angle 919 and the distance 971 from light receiving surface 914 to color pixels 118 are such that only color pixel groups 118′ located close to sample component 950(1) are capable of detecting emission 942(1) originating from sample component 950(1). For color pixel groups 118′, lines 943 outline the portion of acceptance angle 919 that includes a line of sight to sample component 950(1). Other color pixel groups 118 do not include a line of sight to sample component 950(1) that is within acceptance angle 919.

In an embodiment, acceptance angle 919 and distance 971 are such that only color pixel groups 118 at locations less than one color pixel group 118 away, in a direction parallel to light receiving surface 914, are capable of detecting emission from a sample component located on light receiving surface 914. In this embodiment, color pixel groups 118 together generate a minimally spatially blurred color image 146, or a portion thereof, of sample components on light receiving surface 914. In another embodiment, acceptance angle 919 and distance 971 cooperate to result in the rate of occurrence of overlapping fluorescence events, in a color image 146 of a fluidic sample 150 containing sample components of interest at a typical concentration, being below a desired threshold. In yet another embodiment, acceptance angle 919 is sufficiently small that color image 146 of a fluidic sample 150 containing uniformly spaced sample components of interest at a typical concentration is free of overlapping events.

For imaging of fluidic samples 150, in which the sample components of interest do not necessarily settle to light receiving surface 914, spatial blur is minimized when depth 188 of recess 112 is small. Therefore, in certain embodiments of color-sensitive image sensor 100, depth 188 is the minimal height that allows for depositing fluidic sample 150 in the microfluidic channel defined by recess 112 and cover 120.

In one embodiment, depth 188 is less than 10 micron or less than 1 micron. Such low values of depth 188 minimize the required volume of fluidic sample 150 and any associated assay reagents. In another embodiment, depth 188 is greater than 10 micron, for example hundreds of microns or millimeter-sized.

In an embodiment, the transverse size of color pixel groups 118 is significantly smaller than the size of sample components of interest in the microfluidic channel associated with recess 112, wherein the transverse size of color pixel group 118 is defined as the largest dimension of color pixel group 118 in a plane parallel to light receiving surface 914. This allows for accurate size and shape determination of sample components of interest, and may further allow for identification of sample components of interest based upon the size of the event in color image 146. For example, a sample component of interest may be found as a subset of detected events that further meet specified size and/or shape criteria.

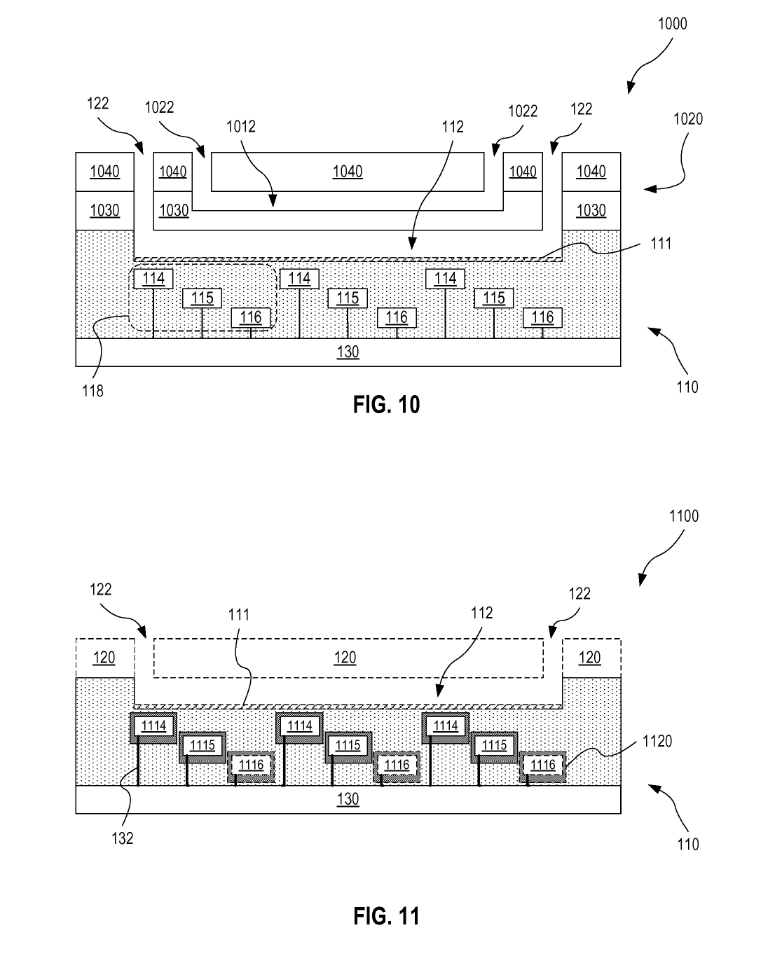

FIG. 10 illustrates a color-sensitive image sensor 1000 with multilevel microfluidics. Color sensitive image sensor is an embodiment of color-sensitive image sensor 100 (FIG. 1), which includes at least one external microfluidic channel in addition to the microfluidic channel(s) associated with recess(es) 112. Color-sensitive image sensor 1000 includes a cover 1020 that implements at least one external microfluidic channel. Cover 1020 is an embodiment of cover 120, and includes a substrate 1030 and a substrate 1040. Substrate 1030 is in contact with silicon substrate 110 and cooperates with recess(es) 112 to define microfluidics embedded in silicon substrate 110. Substrate 1030 includes at least one recess 1012. Substrate 1040 is in contact with substrate 1030 such that substrate 1040 and recess 1012 cooperate to define a microfluidic channel external to silicon substrate 110.

Substrates 1030 and 1040 have through holes 1022 that form inlet and outlet ports for the microfluidic channel defined by recess 1012. In addition, substrate 1040 has through holes 1022 that form inlet and outlet ports for the microfluidic channel(s) defined by recess(es) 1012 and substrate 1040.

Substrates 1030 and 1040 are for example glass and/or plastic substrates. Each recess 1012 includes at least a portion that is located above a recess 112, i.e., offset from recess in a direction perpendicular to recess 112, such that light propagating from this portion of recess 1012 and light propagating from recess 112 toward a photosensitive region 114, 115, and/or 116 experience the same path length to the photosensitive region in question.

FIG. 11 illustrates one exemplary color-sensitive image sensor 1100 configured to reduce spectral blur. Color-sensitive image sensor 1100 is an embodiment of color-sensitive image sensor 100 (FIG. 1). Color-sensitive image sensor 1100 includes a silicon substrate 1110 that is an embodiment of silicon substrate 110. Silicon substrate 1110 includes a plurality of negatively doped (n-type doped) regions 1114, a plurality of n-type doped regions 1115, and, optionally, a plurality of n-type doped regions 1116. N-type doped regions 1114, 1115, and 1116 implement photosensitive regions 114, 115, and 116. N-type doped regions 1114, 1115, and 1116 may have depth ranges different from those shown in FIG. 11, without departing from the scope hereof. In addition, silicon substrate 1110 may include additional n-type doped regions having depth range(s) different from those of n-type doped regions 1114, 1115, and 1116. Each n-type doped region 1114 and 1115 (and 1116, if included), is substantially surrounded by a positively doped (p-type doped) region 1120. P-type doped region 1120 may have extent different from that shown in FIG. 11, without departing from the scope hereof. For example, p-type doped region 1120 may extend to recess 112. For clarity of illustration, only one p-type doped region 1120 is labeled in FIG. 11.

P-type doped region 1120 is likely to annihilate any electrons generated by p-type doped region 1120 in response to light incident thereupon before such electrons would be able to migrate to one of n-type doped regions 1114 and 1115 (and 1116, if included). Therefore, P-type doped region 1120 may eliminate or reduce spectral blur caused by migration of photogenerated electrons into the corresponding n-type doped regions 1114, 1115, or 1116 from portions of silicon substrate 1110 external to the n-type doped region in question.

Electrical connections 132 form a break in each p-type doped region 1120, and p-type doped region may have other openings. However, any extent of p-type doped material adjacent to an n-type doped region 1114, 1115, or 1116 reduces the probability of electron migration into the n-type doped region, thus reducing probability of spectral blur.

Without departing from the scope hereof, regions 1114, 1115, and 1116 may be p-type doped regions and region 1120 may be an n-type doped region.

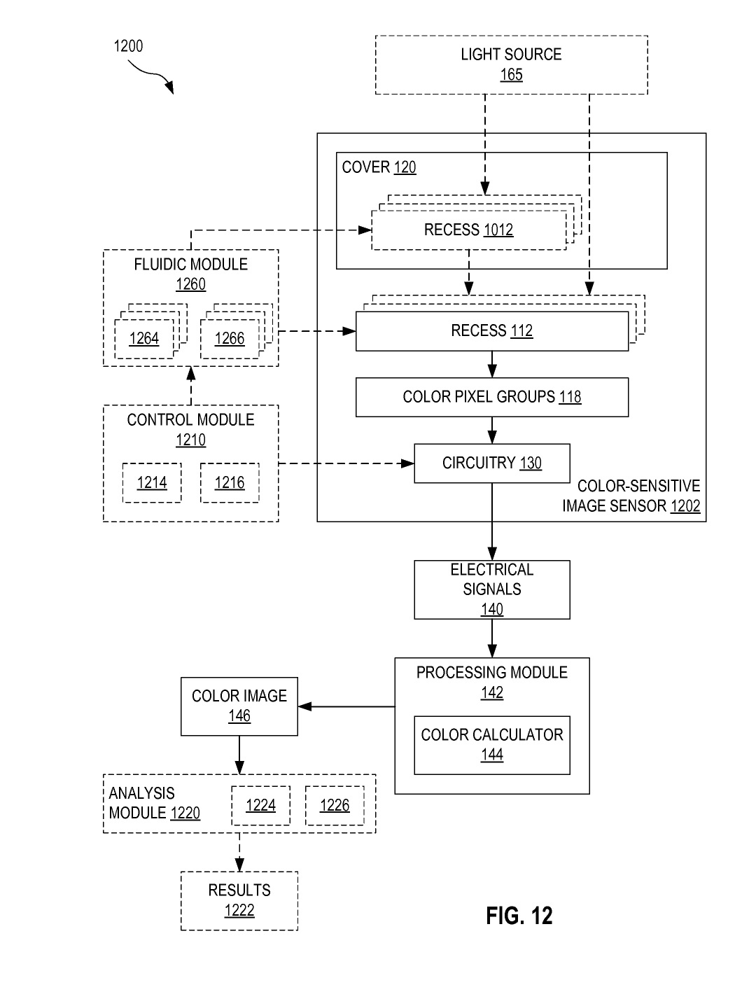

FIG. 12 illustrates one exemplary sample imaging system 1200 that utilizes a color-sensitive image sensor 1202, having embedded microfluidics, to generate color image 146 (FIG. 1) of fluidic sample 150. Color-sensitive image sensor 1202 is an embodiment of color-sensitive image sensor 100, which includes cover 120. Sample imaging system 1200 includes color-sensitive image sensor 100 and processing module 142. Similar to the discussion of color-sensitive image sensor 100, in reference to FIG. 1, processing module 142 may be incorporated into color-sensitive image sensor 1202.

In an embodiment, sample imaging system 1200 includes a control module 1210. Control module 1210 is communicatively coupled with electronic circuitry 130. Control module 1210 controls at least portions of the functionality of electronic circuitry 130. For example, control module 1210 controls electronic circuitry to effect image capture by color-sensitive image sensor 1202 of at least one fluidic sample 150 deposited in (a) one or more embedded microfluidic channels associated with one or more respective recesses 112 and, optionally, (b) one of more external microfluidic channels associated with recesses 1012 (FIG. 10). Control module 1210 may also control output of electrical signals by electronic circuitry 130 to processing module 142.

In an embodiment, sample imaging system 1200 includes an analysis module 1220 that analyzes color image 146 to determine results 1222. Analysis module 1220 is communicatively coupled with processing module 142 and receives color image 146 therefrom. Analysis module 1220 is, for example, implemented as a computer or a microprocessor. In such an implementation, analysis module 1220 includes (a) machine-readable instructions 1224 encoded in non-transitory memory and (b) a processor 1226 that executes machine-readable instructions 1224 on color image 146 to determine results 1222. Results 1222 include, for example, (a) a list of detected events in color image 146 and their color properties, (b) the number and/or concentration of sample components of interest in fluidic sample 150, and/or (c) a diagnostic result such as the presence or absence of one or more sample components of interest in fluidic sample 150.

In an embodiment, sample imaging system 1200 includes a fluidic module 1260 that controls, at least in part, fluidic operations related to fluidic sample 150. Fluidic module 1260 may include one or more fluidic pumps 1264 and/or one or more fluidic valves 1266 to control such fluidic operations. In one example, fluidic module 1260 deposits fluidic sample 150 into a microfluidic channel associated with recess 112 or recess 1012, optionally using a pump 1264. In another example, fluidic module 1260 opens a valve 1266 to allow fluidic sample 150 to flow into a microfluidic channel associated with recess 112 or recess 1012. In yet another example, fluidic module 1260 closes a valve 1266 to prevent flow of fluidic sample 150 into a microfluidic channel associated with recess 112 or recess 1012. In a further example, fluidic module 1260 controls addition of assay reagents to a microfluidic channel associated with recess 112 or recess 1012.

Optionally, sample imaging system 1200 includes light source 165. Optional light source 165 illuminates at least one microfluidic channel associated with recess 112 or recess 1012.

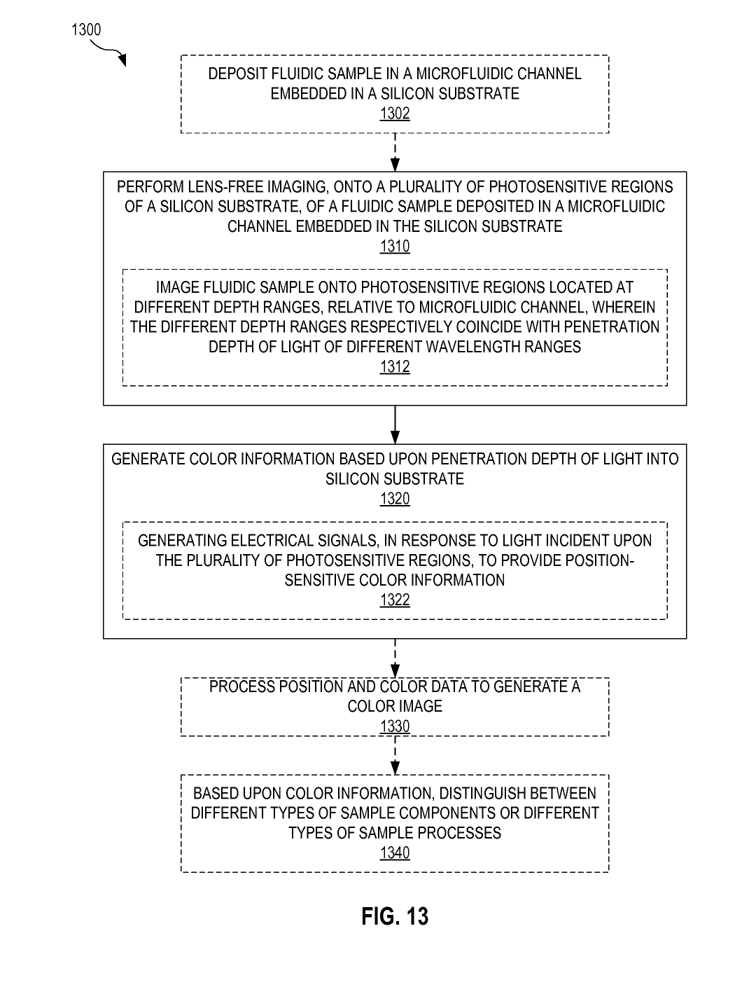

FIG. 13 illustrates one exemplary method 1300 for generating a color image of a fluidic sample, utilizing a color-sensitive image sensor with embedded microfluidics. Color-sensitive image sensor 100 (FIG. 1) may perform at least a portion of method 1300. Sample imaging system 1200 (FIG. 12) may perform at least a portion of method 1300.

A step 1310 performs lens-free imaging, onto a plurality of photosensitive regions of a silicon substrate, of a fluidic sample deposited in a microfluidic channel embedded in the silicon substrate. In an embodiment, method 1300 performs a step 1312 to achieve step 1310. In step 1312, method 1300 images the fluidic sample onto photosensitive regions located at different depth ranges, relative to the embedded microfluidic channel. The different depth ranges respectively coincide with penetration of light of different wavelength ranges.

In one example of 1312, color-sensitive image sensor 100 images, without using an image-forming objective, light received from fluidic sample 150, deposited in the microfluidic channel associated with recess 112, onto photosensitive regions 114 and 115 (and optionally other photosensitive regions such as photosensitive regions 116).

A step 1320 generates color information based upon penetration depth of light from the fluidic sample, deposited in the embedded microfluidic channel, into the silicon substrate. In an embodiment, method 1300 performs a step 1322 to achieve step 1320. In step 1322, method 1300 provides position-sensitive color information by generating electrical signals in response to light incident upon the plurality of photosensitive regions of step 1310.

In one example of step 1322, each photosensitive region 114 and 115 (and optionally each of other photosensitive regions such as photosensitive regions 116) generates an electrical signal, in response to light absorbed by the photosensitive region, and communicates this electrical signal to electronic circuitry 130. Electronic circuitry processes such electrical signals to produce electrical signal 140.

In an embodiment, method 1300 includes a step 1302 of depositing the fluidic sample in the embedded microfluidic channel. In one example of step 1302, a user deposits fluidic sample 150 in the microfluidic channel associated with recess 112. In another example of step 1302, fluidic module 1260 deposits fluidic sample 150 in the microfluidic channel associated with recess 112.

In an embodiment, method 1300 includes a step 1330 of processing position and color data, generated by steps 1310 and 1320, to generate a color image. In one example of step 1330, processing module 142 executes color calculator 144 on electrical signals 140 to produce color image 146.

Optionally, method 1300 includes a step 1340, wherein color information is used to distinguish between different types of sample components or processes in the fluidic sample deposited in the embedded microfluidic channel. In one example of step 1340, analysis module 1220 processes color image 146, as discussed in reference to FIG. 12, to produce an embodiment of results 1222 that includes classification of different components of, or processes in, sample 150, based upon color information from color image 146.

Method 1300 may be extended to imaging of multiple fluidic samples using multiple microfluidic channels embedded in the same silicon substrate, without departing from the scope hereof. Also without departing from the scope hereof, method 1300 may be extended to image one of more fluidic samples deposited in one or more external microfluidic channels, in addition to the fluidic sample(s) deposited in the embedded microfluidic channel(s), for example as discussed in reference to FIG. 10.

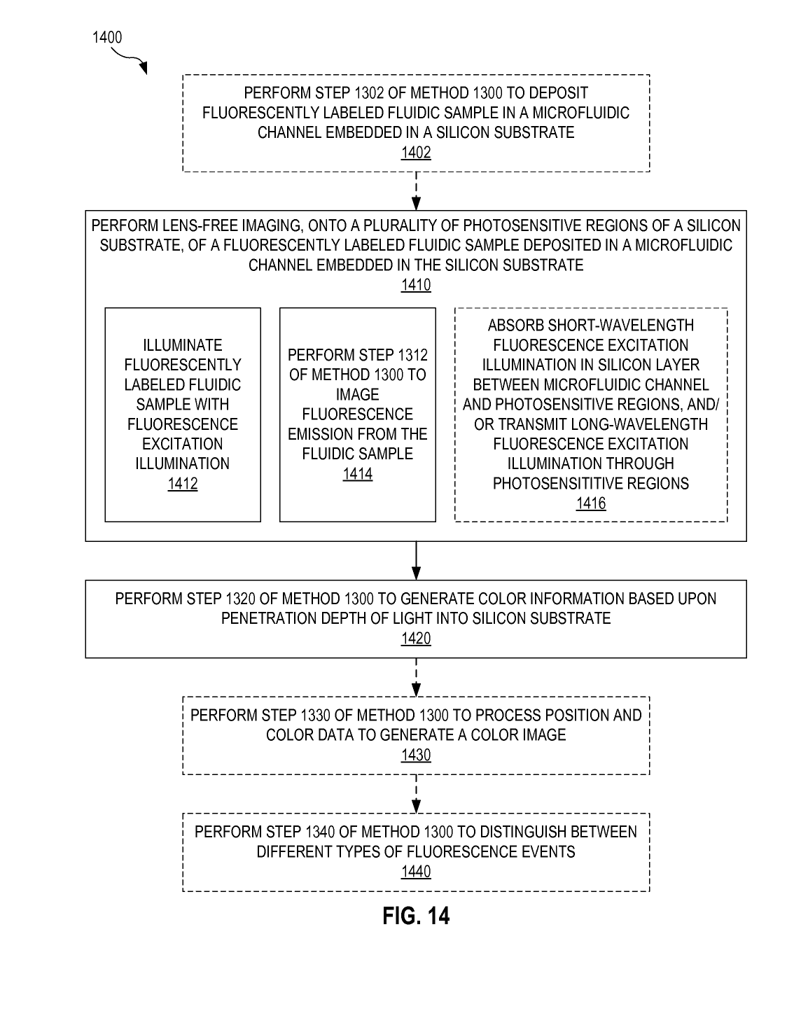

FIG. 14 illustrates one exemplary method 1400 for color fluorescence imaging of a fluidic sample, utilizing a color-sensitive image sensor with embedded microfluidics. Method 1400 is an embodiment of method 1300 (FIG. 13). Color-sensitive image sensor 100 (FIG. 1) may perform at least a portion of method 1400. Sample imaging system 1200 (FIG. 12) may perform at least a portion of method 1300. Method 1400 may be implemented in fluorescence measurements utilizing a single fluorescence emission color, or a multiplexed fluorescence measurement utilizing multiple different fluorescence emission colors.

A step 1410 performs lens-free imaging, onto a plurality of photosensitive regions of a silicon substrate, of a fluorescently labeled fluidic sample deposited in a microfluidic channel embedded in the silicon substrate. Step 1410 is an embodiment of step 1310. Step 1410 includes steps 1412 and 1414.

In step 1412, the fluorescently labeled fluidic sample is illuminated with fluorescence excitation illumination. In one example of step 1412, light source 165 produces fluorescence excitation illumination, an embodiment of illumination 160, to illuminate a fluorescently labeled fluidic sample 150 deposited in the microfluidic channel associated with recess 112.

In step 1414, method 1400 performs step 1312 of method 1300 to image fluorescence emission, induced by step 1412, from the fluidic sample. An example of step 1414 is discussed in reference to color-sensitive image sensor 300 (FIG. 3) and applies to all of color-sensitive image sensors 100, 300, 400, 500, 600, 700, 800, 1000, and 1100 of FIGS. 1, 3-8, 10, and 11.

Optionally, step 1410 includes a step 1416 of filtering out fluorescence excitation illumination. In step 1416, short-wavelength fluorescence excitation illumination is absorbed in a silicon layer located between the microfluidic channel and the photosensitive regions, and/or long-wavelength fluorescence excitation illumination is transmitted through the photosensitive regions. Although not illustrated in FIG. 14, step 1416 may filter out fluorescence excitation illumination by detecting fluorescence excitation illumination using photosensitive regions located at a depth range different from the depth range(s) associated with fluorescence emission. Examples of step 1416 are discussed in reference to color-sensitive image sensor 300 and apply to all of color-sensitive image sensors 100, 300, 400, 500, 600, 700, 800, 1000, and 1100.

In a step 1420, method 1400 performs step 1320 of method 1300 to generate color information based upon penetration depth of light into the silicon substrate, as discussed in reference to FIG. 13.

Optionally, method 1400 includes a step 1402, wherein method 1400 performs step 1302 of method 1300 to deposit the fluorescently labeled fluidic sample in the embedded microfluidic channel, as discussed in reference to FIG. 13.

Method 1400 may further include a step 1430 of performing step 1330 of method 1300 to generate a color image by processing position and color data, as discussed in reference to FIG. 13.

In an embodiment, method 1400 includes a step 1440 of performing step 1340 of method 1300 to distinguish between different types of fluorescence events. In one example of step 1440, method 1400 uses the color data to distinguish between different types of fluorescence emission, and optionally, based thereupon, identifies different types of sample components. Without departing from the scope hereof, step 1440 may use the color data to distinguish between fluorescence excitation illumination and fluorescence emission.

Method 1400 may be extended to fluorescence imaging of multiple fluorescently labeled fluidic samples using multiple microfluidic channels embedded in the same silicon substrate, without departing from the scope hereof. Also without departing from the scope hereof, method 1400 may be extended to image fluorescence from one of more fluorescently labeled fluidic samples deposited in one or more external microfluidic channels, in addition to the fluorescently labeled fluidic sample(s) deposited in the embedded microfluidic channel(s), for example as discussed in reference to FIG. 10.

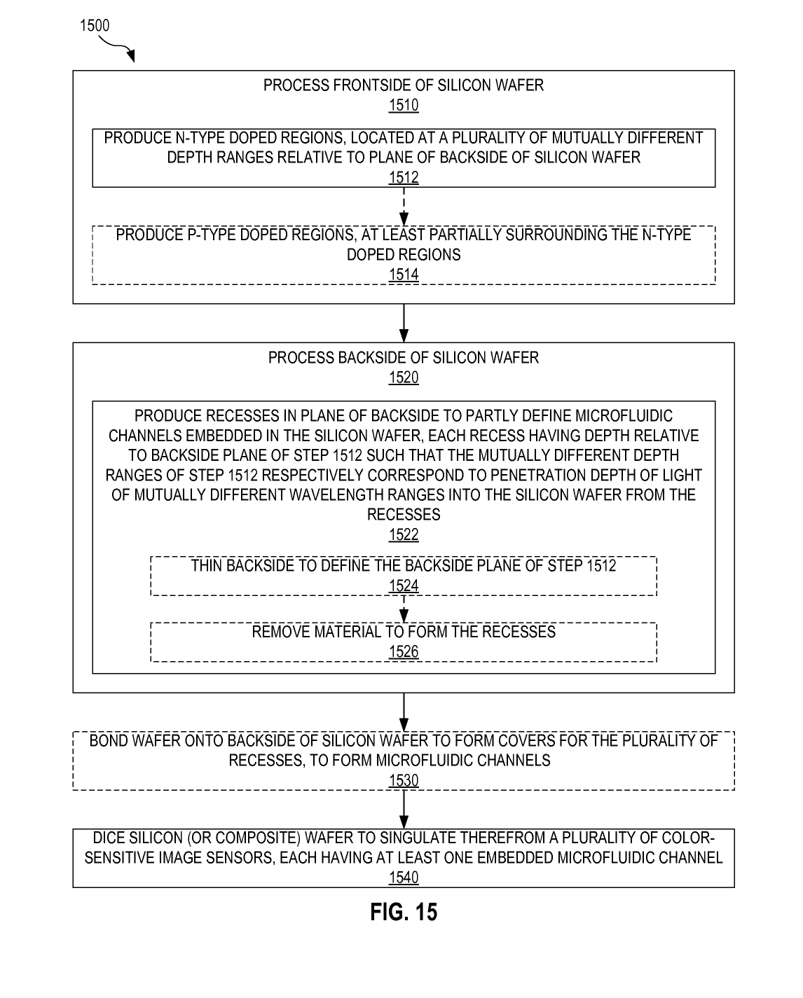

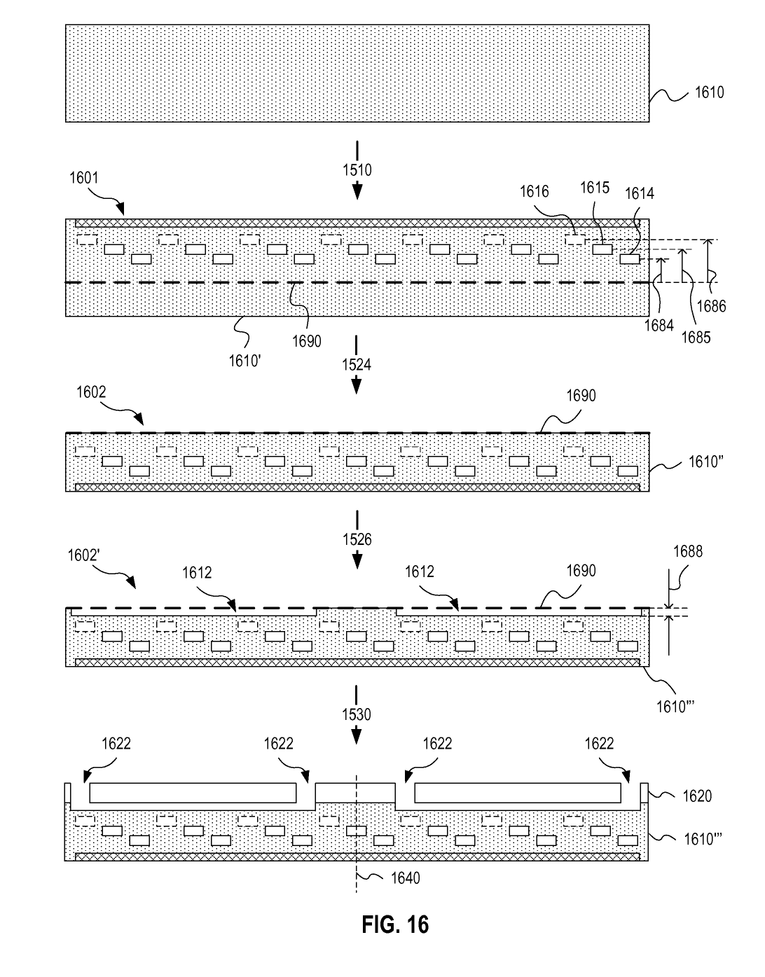

FIG. 15 is a flowchart illustrating one exemplary wafer-level method 1500 for manufacturing a plurality of color-sensitive image sensors 100 (FIG. 1) with embedded microfluidics. FIG. 16 schematically illustrates, in cross-sectional sideview, steps of method 1500. FIGS. 15 and 16 are best viewed together.

In a step 1510, method 1500 processes one side, referred to as frontside 1601, of a silicon wafer 1610, to produce a silicon wafer 1610′. Step 1510 includes a step 1512 of producing (a) a plurality of n-type doped regions 1614 located at depth 1684 relative to a plane 1690, (b) a plurality of n-type doped regions 1615 located at depth 1685 relative to plane 1690, and optionally (c) a plurality of n-type doped regions 1616 located at depth 1686 relative to plane 1690. N-type doped regions 1614, 1615, and 1616 implement photosensitive regions 114, 115, and 116. For clarity of illustration, not all n-type doped regions 1614, 1615, and 1616 are labeled in FIG. 16. As discussed below, plane 1690 will in subsequent step 1520 become the plane of the backside 1602 of silicon wafer 1610, wherein backside 1602 is the side of silicon wafer 1610 that faces away from frontside 1601.

Herein, “silicon wafer” refers to a wafer based upon silicon and/or derivative(s) of silicon. A “silicon wafer”, as referred to herein, may include (a) dopants that locally alter properties of the silicon or silicon-derived material and (b) conductive material, such as metal, forming electronic circuitry.

Without departing from the scope hereof, depths 1684, 1685, and 1686 may be different from those shown in FIG. 16, and silicon wafer 1610 may include a different number of n-type doped regions than shown in FIG. 16, including n-type doped regions located at depth different from those of n-type doped regions 1614, 1615, and 1616. Furthermore, the n-type doped regions may be arranged differently from the illustration in FIG. 16, for example according to the layouts depicted in FIG. 6, 7, or 8.

In an embodiment, step 1510 further includes a step 1514 of producing p-type doped regions that at least partially surround n-type doped regions 1614 and 1615, and optionally other n-type doped regions such as n-type doped regions 1616. This configuration is discussed in reference to FIG. 11.

Step 1510 may perform steps 1512 and 1514 in any order, including simultaneously or partially overlapping in time. In one example of step 1510, one or both of steps 1512 and 1514 are performed via ion-implantation of dopants.

In a step 1520, method 1500 processes backside 1602 of silicon wafer 1610′. Step 1520 includes a step 1522 of producing recesses 1612 in plane 1690 to partly define microfluidic channels embedded in the silicon wafer. Each recess 1612 has depth 1688 relative to plane 1690 such that (a) the mutually different depth ranges of step 1512 respectively correspond to penetration depth of light of mutually different wavelength ranges into silicon wafer 1610 from recesses 1612, and (b) the depth 1688 corresponds to a desired extent of the microfluidic channels in a dimension perpendicular to plane 1690. Step 1522 may produce more recesses 1612 than shown in FIG. 16, without departing from the scope hereof.

Step 1522 may include steps 1524 and 1526. In step 1524, backside 1602 of silicon wafer 1610′ is thinned to plane 1690, for example using methods known in the art. Step 1524 produces a silicon wafer 1610″. In step 1526, material is removed from backside 1602 of silicon wafer 1610″ to form recesses 1612. Step 1526 may be performed using methods known in the art, such as etching. Step 1526 produces a silicon wafer 1610′″. Without departing from the scope hereof, step 1526 may be performed before step 1524.

In an embodiment, method 1500 includes a step 1530, wherein a wafer 1620 is bonded to backside 1602 of silicon wafer 1610′″ to form covers for the plurality of recesses 1612. Step 1530 thus produces a plurality of microfluidic channels defined by recesses 1612 and wafer 1620. Step 1530 may use bonding methods known in the art including adhesive bonding (such as epoxy bonding), anodic bonding, direct bonding, and plasma activated bonding. Wafer 1620 may include through holes 1622 to form inlet and outlet ports for the microfluidic channels associated with recesses 1612. Alternatively, through holes 1622 may be produced in a subsequent step not illustrated in FIGS. 15 and 16. In addition, wafer 1620 may include microfluidic channels, for example the microfluidic channels associated with recesses 1012 (FIG. 10).

In a step 1540, silicon wafer 1610′″, optionally with wafer 1620 bonded thereto, is diced to produce a plurality of color-sensitive image sensors 100. Step 1540 may utilize methods known in the art.

Although not illustrated in FIGS. 15 and 16, in embodiments of method 1500, which do not include step 1530, cover 120 may be bonded to color-sensitive image sensor 100 in a subsequent step. In one scenario, a custom cover 120 is bonded to color-sensitive image sensor 100 to meet specific user needs.

Combinations of Features

Features described above as well as those claimed below may be combined in various ways without departing from the scope hereof. For example, it will be appreciated that aspects of one color-sensitive image sensor with embedded microfluidics, or associated method, described herein may incorporate or swap features of another color-sensitive image sensor with embedded microfluidics, or associated method, described herein. The following examples illustrate some possible, non-limiting combinations of embodiments described above. It should be clear that many other changes and modifications may be made to the methods and device herein without departing from the spirit and scope of this invention:

(A1) A color-sensitive image sensor with embedded microfluidics may include a silicon substrate having (a) at least one recess partly defining at least one embedded microfluidic channel and (b) a plurality of photosensitive regions for generating position-sensitive electrical signals in response to light from the at least one recess.

(A2) In the color-sensitive image sensor denoted as (A1), at least two of the photosensitive regions may be respectively located at at least two mutually different depth ranges, relative to the at least one recess, to provide color information.

(A3) In the color-sensitive image sensor denoted as (A2), the at least two mutually different depth ranges may respectively coincide with penetration depth of light of at least two mutually different wavelength ranges.

(A4) In the color-sensitive image sensors denoted as (A1) through (A3), the plurality of photosensitive regions may be arranged in a plurality of color pixel groups for generating position-sensitive color information.

(A5) In the color-sensitive image sensor denoted as (A4), each color pixel group may include (a) a first photosensitive region located at a first depth range, relative to the at least one recess, wherein the first depth range coincides with penetration depth of light of a first wavelength range, and (b) a second photosensitive region located at a second depth range, relative to the at least one recess, wherein the second depth range coincides with penetration depth of light of a second wavelength range that is different from the first wavelength range.

(A6) In the color-sensitive image sensor denoted as (A5), each color pixel group may further include a third photosensitive region located at a third depth range, relative to the at least one recess, wherein the third depth range coincides with penetration depth of light of a third wavelength range that is different from both the first wavelength range and the second wavelength range.

(A7) In the color-sensitive image sensor denoted as (A6), the first, second, and third depth ranges may be such that the position-sensitive electrical signals together specify primary color information.

(A8) In the color-sensitive image sensor denoted as (A7), the primary color information may be red, green, and blue color information.

(A9) In the color-sensitive image sensors denoted as (A1) through (A8), each photosensitive region may be a negatively doped silicon region.

(A10) In the color-sensitive image sensor denoted as (A9), each negatively doped region may be at least partly surrounded by a positively doped region for cancelling electrical carriers generated by the light near but outside the negatively doped region, to reduce spectral blur.

(A11) The color-sensitive image sensors denoted as (A1) through (A11) may further include a cover in contact with the silicon substrate for, in cooperation with the silicon substrate, defining the at least one embedded microfluidic channel.

(A12) In the color-sensitive image sensor denoted as (A11), the cover may include at least one external microfluidic channel for, together with the at least one embedded microfluidic channel, forming a multilevel microfluidic network.

(A13) In the color-sensitive image sensor denoted as (A12), portions of the cover, associated with light propagation between the at least one external microfluidic channel and the plurality of photosensitive regions, may be substantially transmissive to visual light.

(A14) In the color-sensitive image sensors denoted as (A12) and (A13), at least a portion of the at least one external microfluidic channel may have same transverse location as at least a portion of the at least one recess, for enabling color-sensitive imaging of the at least one external microfluidic channel by the plurality of photosensitive regions, wherein transverse location refers to location in dimensions parallel to surface of the silicon substrate associated with the at least one recess.

(A15) In the color-sensitive image sensors denoted as (A1) through (A14), the silicon substrate may include a silicon layer, that is not negatively doped, between the at least one recess and the plurality of photosensitive regions for absorption of fluorescence excitation light used to excite fluorescence in a fluidic sample disposed in the at least one recess.

(B1) A method for generating a color image of a fluidic sample may include performing imaging, onto a plurality of photosensitive regions of a silicon substrate, of a fluidic sample deposited in a microfluidic channel embedded in the silicon substrate.

(B2) In the method denoted as (B1), the step of performing imaging may include performing lens-free imaging of the fluidic sample onto a plurality of photosensitive regions of the silicon substrate located at a plurality of mutually different depth ranges relative to the microfluidic channel, wherein the mutually different depth ranges respectively coinciding with penetration depth of light of mutually different wavelength ranges

(B3) The methods denoted as (B1) and (B2) may further include generating color information based upon penetration depth of light into the silicon substrate.

(B4) In the method denoted (B3), the step of generating color information may include generating electrical signals, in response to light incident upon the plurality of photosensitive regions, to provide position-sensitive color information.

(B5) The method denoted as (B4) may further include processing the electrical signals to determine the color image.

(B6) In the methods denoted as (B1) through (B5), the color image may be a fluorescence image.

(B7) The method denoted as (B6) may include absorbing fluorescence excitation light incident upon the silicon substrate in a silicon layer located in the silicon substrate between the microfluidic channel and at least a portion of the plurality of photosensitive regions.

(B8) The method denoted as (B6) may include substantially transmitting fluorescence excitation light incident on one of the plurality of photosensitive regions through the one of the plurality of photosensitive regions.

(B9) The methods denoted as (B1) through (B8) may further include performing lens-free color imaging through the microfluidic channel of a fluidic sample deposited in an external microfluidic channel located externally to the silicon substrate, using the plurality of photosensitive regions.

(C1) A wafer-level method for manufacturing a plurality of color-sensitive image sensors with embedded microfluidics may include (a) processing the frontside of a silicon wafer to produce a plurality of doped regions, wherein the doped regions are located at a plurality of mutually different depth ranges relative to plane of the backside of the silicon wafer, and (b) processing the backside to partly define a plurality of embedded microfluidic channels by producing, in the plane of the backside, recesses having depth relative to the plane of the backside such that the mutually different depth ranges respectively correspond to penetration depth of light of mutually different wavelength ranges into the silicon wafer from the recesses.

(C2) The wafer-level method denoted as (C1) may further include dicing the silicon substrate to singulate therefrom the color-sensitive image sensors, wherein each of the color-sensitive image sensors includes at least one of the embedded microfluidic channels.

(C3) In the wafer-level methods denoted as (C1) and (C2), the step of processing the backside may include thinning the backside to define the plane of the backside and etching the recesses.

(C4) In the wafer-level method denoted as (C3), the step of thinning may include thinning the backside by an amount such that the depth of the recesses, relative to the plane of the backside, corresponds to a desired extent of the microfluidic channels in a dimension perpendicular to the plane of the backside.

(C5) The wafer-level methods denoted as (C1) through (C4) may further include bonding a cover to the backside.

(C6) In the wafer-level method denoted as (C5), the cover may include a plurality of external microfluidic channels.

(C7) In the wafer-level method denoted as (C6), each of the plurality of external microfluidic channels may, together with at least one of the embedded microfluidic channels, form a multilevel microfluidic network imageable by doped regions associated with one of the color-sensitive image sensors.

Changes may be made in the above devices and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present system and method, which, as a matter of language, might be said to fall therebetween.

What is claimed is:

1. A color-sensitive image sensor with embedded microfluidics, comprising:
a silicon substrate including (a) at least one recess partly defining at least one embedded microfluidic channel and (b) a plurality of photosensitive regions for generating position-sensitive electrical signals in response to light from the at least one recess, at least two of the photosensitive regions respectively located at at least two mutually different depth ranges, relative to the at least one recess, to provide color information.

2. The color-sensitive image sensor of claim 1, the at least two mutually different depth ranges respectively coinciding with penetration depth of light of at least two mutually different wavelength ranges.

3. The color-sensitive image sensor of claim 1, the plurality of photosensitive regions being arranged in a plurality of color pixel groups for generating position-sensitive color information, each color pixel group comprising:
a first photosensitive region located at a first depth range, relative to the at least one recess, coinciding with penetration depth of light of a first wavelength range; and
a second photosensitive region located at a second depth range, relative to the at least one recess, coinciding with penetration depth of light of a second wavelength range that is different from the first wavelength range.

4. The color-sensitive image sensor of claim 3, each color pixel group further comprising a third photosensitive region located at a third depth range, relative to the at least one recess, coinciding with penetration depth of light of a third wavelength range that is different from both the first wavelength range and the second wavelength range.

5. The color-sensitive image sensor of claim 4, the first, second, and third depth ranges being such that the position-sensitive electrical signals together specify primary color information.

6. The color-sensitive image sensor of claim 5, the primary color information being red, green, and blue color information.

7. The color-sensitive image sensor of claim 1, each photosensitive region being a negatively (n-type) doped silicon region.

8. The color-sensitive image sensor of claim 7, each n-type doped region being at least partly surrounded by a positively (p-type) doped region for cancelling electrical carriers generated by the light near but outside the n-type doped region, to reduce spectral blur.

9. The color-sensitive image sensor of claim 1, further comprising a cover in contact with the silicon substrate for, in cooperation with the silicon substrate, defining the at least one embedded microfluidic channel.

10. The color-sensitive image sensor of claim 9, the cover comprising at least one external microfluidic channel for, together with the at least one embedded microfluidic channel, forming a multilevel microfluidic network.

11. The color-sensitive image sensor of claim 10, at least a portion of the at least one external microfluidic channel having same transverse location as at least a portion of the at least one recess, for enabling color-sensitive imaging of the at least one external microfluidic channel by the plurality of plurality of photosensitive regions, wherein transverse location refers to location in dimensions parallel to surface of the silicon substrate associated with the at least one recess.

12. The color-sensitive image sensor of claim 1, the silicon substrate comprising a silicon layer, that is not negatively (n-type) doped, between the at least one recess and the plurality of photosensitive regions for absorption of fluorescence excitation light used to excite fluorescence in a fluidic sample disposed in the at least one recess.

13. A method for generating a color image of a fluidic sample, comprising:
performing imaging, onto a plurality of photosensitive regions of a silicon substrate, of a fluidic sample deposited in a microfluidic channel embedded in the silicon substrate; and
generating color information based upon penetration depth of light into the silicon substrate.

14. The method of claim 13, wherein
the step of performing lens-free imaging comprises performing lens-free imaging of the fluidic sample onto a plurality of photosensitive regions of the silicon substrate located at a plurality of mutually different depth ranges relative to the microfluidic channel, the mutually different depth ranges respectively coinciding with penetration depth of light of mutually different wavelength ranges; and
the step of generating color information comprises generating electrical signals, in response to light incident upon the plurality of photosensitive regions, to provide position-sensitive color information.

15. The method of claim 14, further comprising:
processing the electrical signals to determine the color image.

16. The method of claim 13, the color image being a fluorescence image, the method further comprising:
absorbing fluorescence excitation light incident upon the silicon substrate in a silicon layer located in the silicon substrate between the microfluidic channel and at least a portion of the plurality of photosensitive regions.

17. The method of claim 13, the color image being a fluorescence image, the method further comprising:
substantially transmitting fluorescence excitation light incident on one of the plurality of photosensitive regions through the one of the plurality of photosensitive regions.

18. The method of claim 13, further comprising:
performing lens-free color imaging through the microfluidic channel of a fluidic sample deposited in an external microfluidic channel located externally to the silicon substrate, using the plurality of photosensitive regions.

19. A wafer-level method for manufacturing a plurality of color-sensitive image sensors with embedded microfluidics, comprising:
processing frontside of a silicon wafer to produce a plurality of doped regions, the doped regions located at a plurality of mutually different depth ranges relative to plane of backside of the silicon wafer;
processing the backside to partly define a plurality of embedded microfluidic channels by producing, in the plane of the backside, recesses having depth relative to the plane of the backside such that the mutually different depth ranges respectively correspond to penetration depth of light of mutually different wavelength ranges into the silicon wafer from the recesses; and
dicing the silicon substrate to singulate therefrom the color-sensitive image sensors, each of the color-sensitive image sensors including at least one of the embedded microfluidic channels.

20. The method of claim 19, the step of processing the backside comprising:
thinning the backside to define the plane of the backside; and
etching the recesses.

21. The method of claim 20, the step of thinning comprising thinning the backside by an amount such that the depth of the recesses, relative to the plane of the backside, corresponds to a desired extent of the microfluidic channels in a dimension perpendicular to the plane of the backside.

22. The method of claim 19 further comprising bonding a cover to the backside, the cover including a plurality of external microfluidic channels, each of the plurality of external microfluidic channels, together with at least one of the embedded microfluidic channels, forming a multilevel microfluidic network imageable by doped regions associated with one of the color-sensitive image sensors.
